(19) United States
(12) Patent Application Publication
(10) Pub. No.: US 2009/0061892 A1
(43) Pub. Date: Mar. 5, 2009

(54) LOCATION ASSISTED CONNECTION TO FEMTOCELL

(75) Inventors: Anthony Lee, San Diego, CA (US); Paul Chun-Hsiung Wei, San Diego, CA (US)

Correspondence Address: HUFFMAN LAW GROUP, P.C., 1900 MESA AVE., COLORADO SPRINGS, CO, 80906, US

(73) Assignee: VIA TELECOM, INC., San Diego, CA (US)

(21) Appl. No.: 12/106,434

(22) Filed: Apr. 21, 2008

Related U.S. Application Data
(60) Provisional application No. 60/968,300, filed on Aug. 27, 2007.

(51) Int. Cl. H04Q 7/20

(52) U.S. Cl. 455/456.1

(57) ABSTRACT

A method for connecting to an access point base station is presented in the application. Current location information of the mobile access terminal may be determined. The current location information may be determined using positioning location circuitry of the mobile access terminal to determine the current location information. Alternatively, the current location information may be determined by receiving the current location information from an external source. The mobile access terminal may determine the current location based on signals from macro base stations or other base stations, e.g., using triangulation. If the current location information indicates, the mobile access terminal may then connect to an access point base station.

### PRIORITY INFORMATION

This application claims benefit of priority of U.S. provisional application Ser. No. 60/968,300 titled “Femto-Cell Searches with Assistance of GPS” filed Aug. 27, 2007 whose inventors are Tony Lee and Paul Wei, which is hereby incorporated by reference in its entirety as though fully and completely set forth herein.

### FIELD OF THE INVENTION

The present invention relates to the field of cellular networks, and more particularly to a method for connecting to access point base stations.

### DESCRIPTION OF THE RELATED ART

In recent years, the use of mobile devices and, in particular, cellular telephones has proliferated. As a result, focus on reception for cellular telephones or other mobile devices, especially in homes or primary residences, has increased. Additionally, typical users of mobile devices use or subscribe to data services for their homes. As a result, femtocells (more generally called access point base stations) have begun to be used in the home. Femtocells provide cellular service to mobile devices using the data service of the user. Thus, these femtocells provide excellent service where mobile devices are used most and typically make use of data plan services (e.g., DSL, fiberoptic, cable, WiMAX, etc.), which may not require a nearby macro cell of the cell phone service provider.

However, current methods for connecting to femtocells (e.g., by cell phones) typically require the detection of the presence of the femtocells, which can lead to lost information to macro base stations and inefficient battery usage. Thus, improvements in connections to femtocells are desired.

### SUMMARY OF THE INVENTION

Various embodiments are presented of a method for connecting to an access point base station (e.g., a femtocell).

Current location information of a mobile access terminal (e.g., a cell phone or mobile phone) may be determined. The current location information may be determined using position location circuitry (e.g., GPS circuitry) of the mobile access terminal to determine the current location information. Alternatively, the current location information may be determined by receiving the current location information from an external source (e.g., from a macro base station). In one embodiment, the mobile access terminal may determine the current location based on signals from macro base stations or other base stations, e.g., using triangulation.

The current location information may include a latitude and longitude coordinate and/or height information.

The current location information may be compared to stored location information of one or more access point base stations to determine if at least one of the one or more access point base stations is in proximity to the mobile access terminal. Each of the one or more access point base stations may be configured to provide wireless communication to mobile access terminals within a local area.

Finally, the method may include connecting to an access point base station of the one or more access point base stations if the comparison indicates that at least one of the one or more access point base stations is in proximity to the mobile access terminal. Connecting to the access point base station may include tuning a receiver to a carrier signal of the access point base station, searching for the access point base station (e.g., a PN offset of the access point base station), decoding one or more access point base station overhead messages, comparing identification information of the access point base station with stored identification information, and/or connecting to the access point base station if the identification information matches the stored identification information.

In one embodiment, e.g., in order to connect to the access point base station, the mobile access terminal may scan for the one or more access point base stations in response to determining that at least one of the one or more access point base stations is in proximity to the mobile access terminal. However, the mobile access terminal may not scan for the one or more access point base stations in response to determining that no access point base stations are in proximity to the mobile access terminal.

### BRIEF DESCRIPTION OF THE DRAWINGS

A better understanding of the present invention can be obtained when the following detailed description of the preferred embodiment is considered in conjunction with the following drawings, in which:

FIG. 1 is an exemplary system including an access point base station according to one embodiment;

FIG. 2 is a diagram illustrating service areas for a macro base station and two access point base stations, according to one embodiment;

FIG. 3 is an exemplary general block diagram of the access point base station according to one embodiment;

FIG. 4 is an exemplary block diagram of the access point base station according to one embodiment;

FIG. 5 is an exemplary block diagram of a mobile device according to one embodiment; and

FIG. 6 is a flowchart of an exemplary method for connecting to the access point base station, according to one embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

### Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Program—the term “program” is intended to have the full breadth of its ordinary meaning. The term “program” includes 1) a software program which may be stored in a memory and is executable by a processor or 2) a hardware configuration program useable for configuring a programmable hardware element.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program may comprise two or more software programs that interoperate in some manner.

Hardware Configuration Program—a program, e.g., a netlist or bit file, that can be used to program or configure a programmable hardware element.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “icomputer system” can be broadly defined to encompass any device (or combination of devices) having at least one processor that executes instructions from a memory medium.

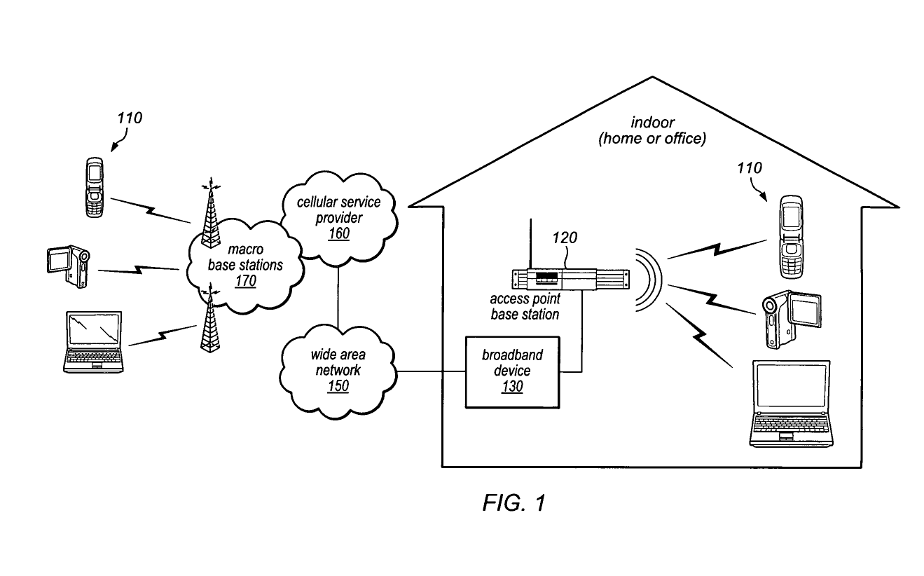

### FIGS. 1-5—EXEMPLARY BLOCK DIAGRAMS OF A COMMUNICATIONS SYSTEM

FIG. 1 illustrates an exemplary system including an access point base station (e.g., a femtocell). The term “access point base station” is intended to include typical definitions (as known by those of skill in the art) of femtocells, home base stations, personal access points (PAPs), and personal 2G-3G (or nG) base stations, among others. In some embodiments, the access point base station may include capabilities of a mobile station transmitter/receiver (transceiver) as well as further functionality described in more detail below. Various embodiments of a method for connecting to an access point base station are provided below.

As shown, FIG. 1 illustrates a home which may include one or more mobile access terminals (also called “mobile devices” herein) 110, an access point base station 120, and a broadband device 130. As also shown, the broadband device may be connected to a wide area network 150, which in turn may be coupled to a cellular service provider 160 which may use macro base stations 170 to service the various mobile devices 110. Further details regarding the operation of the access point base station 120 and its interaction with the mobile devices 110, cellular service provider 160, and macro base stations 170 are provided below.

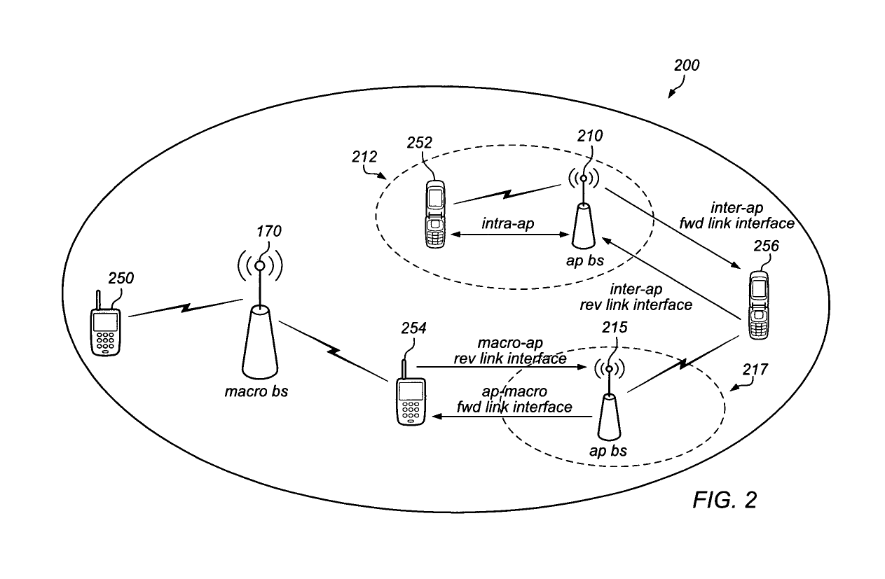

FIG. 2 illustrates an exemplary area 200 which macro base station 170 provides wireless communication services for mobile devices 250, 252, 254, and 256 (exemplary individual mobile devices of mobile devices 110). FIG. 2 also illustrates the coverage areas of access point base stations 210 and 215 which may provide service to mobile devices within their local area (212 and 217 respectively). The term “local area” may be distinguished from the “wide area” coverage provided by a macro base station 170 or cell tower. Thus the term “local area” may refer to an area of coverage ranging from 50-200 meters in radius from the access point base station, and typically provides coverage for (or proximate to) a single home or business. Note that the local area may be configured by the user of the access point base station or by the service provider, e.g., to cover only an area around a home or apartment and/or to reduce interference of other base stations. In this case, access point base station 210 (which may be similar to access point base station 120 of FIG. 1 and may similarly be located in a home) provides service for mobile device 252. Additionally, as indicated, handoffs may be occurring for mobile devices 256 (inter access point base station handoff) and 254 (macro base station and access point base station handoff) entering or leaving the local areas.

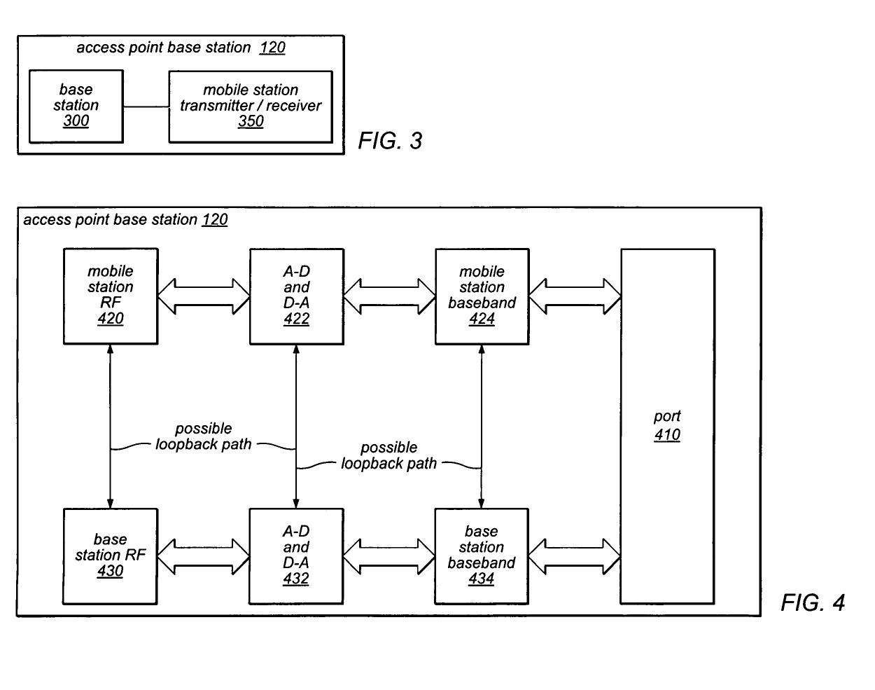

As shown in FIG. 3, the access point base station 120 may include base station circuitry 300 which may be coupled to mobile station transceiver circuitry 350. The base station circuitry 300 and/or the mobile station transceiver circuitry 350 may include or be coupled to a processor and memory to implement their functionality. In one embodiment, each of the base station circuitry and the mobile station transceiver circuitry may have independent processors and memory; however, these components may share a processor and memory.

FIG. 4 illustrates a more specific exemplary block diagram of the access point base station 120. As shown, the access point base station 120 may include a port 410 (or method of access) to reach the wide area network 150, possibly provided by the broadband communications device 130. The port 410 may provide for wired or wireless communication with the broadband communications device 130. In some embodiments, the port 410 may be implemented as an interface or an interconnection network coupled to the broadband communications device 130, base station circuitry 300, and/or mobile station transceiver circuitry 350. A mobile station baseband 424 and base station baseband 434 may be coupled to the port 410. Each baseband component may be in turn connected to analog to digital and digital to analog converters (422 and 432 respectively) which may be connected to respective transceivers (mobile station R/F 420 and base station R/F 430). Various ones of these components may be coupled for loop-back testing (e.g., the mobile station R/F 420 to base station R/F 430, the two digital/analog converters 422 and 422, and/or the two baseband components 424 and 434, among other possible connections). Note that this block diagram is exemplary only and that various ones of the blocks may be replaced, modified, or connected in different manners, as desired. Further note that additional components may be present in the access point base station 120 that are not shown in FIG. 4.

As shown in FIGS. 3 and 4, the base station circuitry 300 and the mobile transceiver circuitry 350 may be included in a same housing of the access point base station 120. The housing may be plastic or metal (e.g., aluminum or other metals) and may take a box-like design. In one embodiment, the housing may include one or more lights or light emitting diodes (LEDs) which indicate the activity or operation of various components of the access point base station 120 (e.g., operation of the base station circuitry 200 and/or the mobile station transceiver circuitry 250, among others).

The housing may include a power supply for providing power to the components of the access point base station 120. The housing may also include one or more ports for coupling to other devices or communications devices. For example, in one embodiment, the housing may include a universal serial bus (USB) port (or other type of port, such as firewire, among others) for attaching devices (e.g., printers, personal music players, personal digital assistants, cell phones, external hard drives, testing devices, media controllers, etc.). Additionally, or alternatively, the one or more ports may include Ethernet ports (e.g., for coupling to a router or the communications device 130, among others), fiber ports, cable ports, etc.

The access point base station 120 may operate to receive wireless communication (e.g., radio frequency (RF) communication) from the one or more mobile devices 110 and provide corresponding signals or communication with mobile operator(s) (or cellular service providers) corresponding to the providers of the mobile devices 110. More specifically, the access point base station 120 may operate to provide communication for the mobile devices 110 using the broadband communications device 130 over an IP wide area network 150 (e.g., the Internet, via the user's internet service provider (ISP)). The broadband device 130 may thus communicate with the cellular service provider 160 via the Internet.

Moreover, the IP wide area network 150 may be private or dedicated to the user using various technologies, for example, lease line, frame relay, digital subscriber line (DSL), or dial-up service. The IP communication may be encrypted or IP tunneling may be used if supported by the IP wide area network 150. The cellular service provider 160 may also be coupled to macro base stations 170 (sometimes referred to as cell phone towers or macro cell stations) which may operate to provide service to the mobile devices 110 when outside of range of the access point base station 120 and/or when the access point base station 120 is disabled or non-operational. Thus, the access point base station 120 may provide bi-directional communication for the mobile devices via an IP network such as the Internet. Stated another way, users in the home may use their cell phones which communicate with the access point base station, wherein the user's voice/data communications may be transmitted/received to/from the cellular service provider over an IP network.

The mobile station transceiver circuitry 350 may operate to communicate with the mobile devices 110 and the cell towers 170 using wireless cellular communication such as RF. However, it should be noted that in some embodiments, the mobile station transceiver circuitry 350 may not communicate directly with the mobile devices 110; instead, it may receive signals from the mobile devices 110 via another component, such as the base station 300. The mobile station transceiver circuitry 350 may be used for loopback testing, reporting of environmental factors, and to provide redundancy when the IP network is down, thus improving cellular reception in the home. Thus, in some embodiments, the mobile station transceiver circuitry 350 may be used to monitor environmental factors of the access point base station 120 (e.g., neighboring macro cell stations, neighboring femtocells, radio frequency traffic in the home, etc.) and may convey that information (e.g., to the service provider via the macro cell station or the IP network, as desired) for configuration of the access point base station 120. This information may be critical during initial (e.g., automatic) set up of the access point base station 120. Correspondingly, macro base station 170 and/or the service provider 160 via the wide area network 150 may communicate with the access point base station 120 during installation of the access point base station 120 to perform set-up operations, e.g., automatically. The mobile station transceiver circuitry 350 may also allow for initiation of testing (e.g., loop-back testing) of the access point base station 120, e.g., in response to signals from the macro base station 170.

The mobile devices (also referred to as access terminals, mobile base stations, and/or mobile access terminals) 110 may include any type of device which may be used in a cellular network, e.g., RF communication. Mobile devices 110 may include cellular (or cell) phones (including smart phones), personal digital assistants (PDAs) with mobile communication capabilities, laptops or computer systems with mobile communication components, and/or any device which is operable to communicate with a cellular network. The mobile device may include various communication circuitry (e.g., RF circuitry), location information circuitry, memory mediums, processors, etc. For example, the mobile device may include a memory medium on which program instructions may be stored for execution by a processor to perform various procedures such as the methods described herein.

The mobile devices may use various different protocols, e.g., cdma2000 (1xRTT and EV-DO), UMB, UMTS, LTE, WiMax, or others). The access point base station may support any or at least a subset of the protocols used by the mobile devices 110, e.g., without modification to the standards or protocols for supporting existing mobile devices.

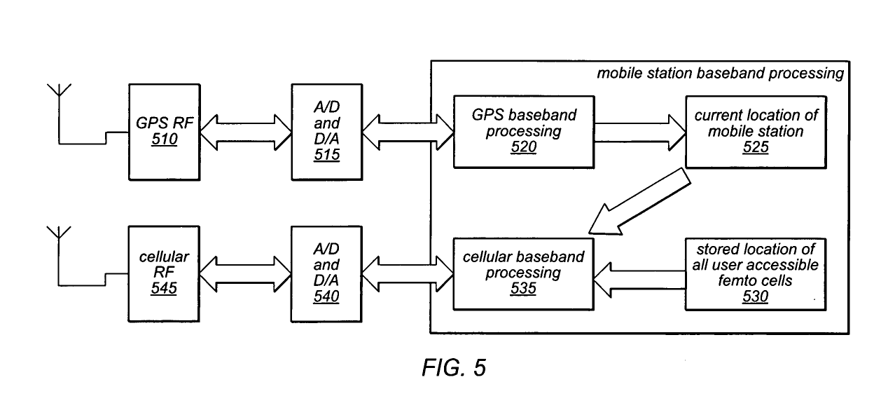

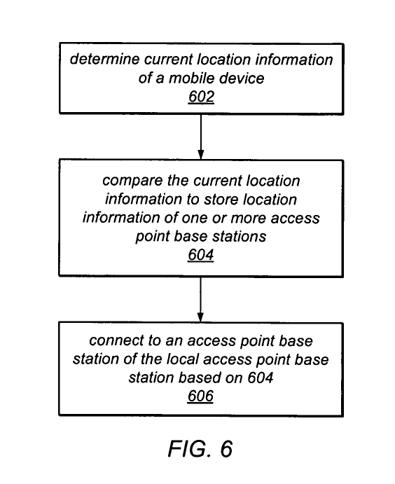

FIG. 5 illustrates an exemplary block diagram of a mobile device, according to one embodiment. As shown, the mobile device (also referred to as access terminal or mobile station) may include a satellite positioning system, e.g., U.S. global positioning system (GPS), radio frequency circuitry 510, which may be coupled to A/D and D/A 515, which may be coupled to GPS baseband processing circuitry 520, which may be processed to determine the current location of the mobile device in 525. As shown, the mobile device GPS receiver may provide location information and the cellular portion of the mobile device may use the previously stored access point base station information in 530 and compare that against the current location information as provided by the GPS receiver in 535. If the location information 525 indicates that there is an access point base station nearby, the mobile device may connect to that access point base station. However, it should be noted that this operation is exemplary only, and further embodiments and alternatives are envisioned, such as those described below with regard to FIG. 6. Finally, A/D and D/A in 540 and cellular RF 545 may be used for external communication.

The broadband device 130 may include a router and/or cable/dsl modem for connecting to the ISP 150. In one embodiment, the broadband device 130 may include a wireless router (or one or more wireless hubs) which may provide wireless communication (e.g., using 802.11x communication technology) for the communications device 120. Additionally, the broadband device 130 may be connected to the wide area network 150 via wired (e.g., cable, DSL, fiberoptic, power lines, etc.) or wireless means (e.g., WiMAX or other wireless communication methods), as desired. Alternatively, or additionally, the broadband device 130 may be coupled to the access point base station 120 remotely, e.g., via a WiMAX wireless connection. Furthermore, in one embodiment, the access point base station 120 may include the broadband device 130 (e.g., in an all-in-one solution for the user).

Thus, the access point base station 120 may provide access to the cellular network via the wide area network 150 (e.g., the Internet) using the broadband device 130 (wired or wirelessly) and may include the mobile station transceiver 350.

### FIG. 6—EXEMPLARY METHOD FOR CONNECTING TO AN ACCESS POINT BASE STATION

FIG. 6 illustrates an exemplary method for connecting to an access point base station. The method shown in FIG. 6 may be used in conjunction with any of the computer systems or devices shown in the above Figures, among other devices. In various embodiments, some of the method elements shown may be performed concurrently, performed in a different order than shown, or omitted. Additional method elements may also be performed as desired. As shown, this method may operate as follows. In the following description, references to the “access point base station” refer to the access point base station 120.

In 602, current location information of a mobile device may be determined. The current location information may include a longitude and latitude of the mobile device (e.g., with a radius of error) or may include a definition of a local area. Additionally, the location information may include height information (e.g., height from sea level or from ground level in the current area, among others). Height information may be particularly useful for connecting to an access point base station that is in an apartment or multilevel building (or alternatively when the mobile device is in a building or area with height variance. In some embodiments, height information may be determined using an altimeter and calibration information from a base station (e.g., a macro base station or access point base station). Alternatively, the current location information may be relative to some other position or location. For example, the current location information may indicate how far the mobile device is from a specific macro base station, one or more access point base stations, or other locations, devices, etc.

In various embodiments, the current location information may be determined by the mobile device or may be received by the mobile device, as desired. For example, in one embodiment, the mobile device may include position location circuitry (e.g., a global positioning system (GPS) module or circuitry) for determining its current location. The satellite positioning system may include at least one of the followings: Russian GLONASS (Global Navigation Satellite System), European Galileo, China Beido, and Indian IRNSS (Indian Regional Navigation Satellite System).

Alternatively, or additionally, the mobile device may be able to determine its current location based on signals received from various macro base stations, WiFi access points, access point base stations, or other devices which the mobile device can detect. In one embodiment, the mobile device may use triangulation methods to determine its current location from these signals (e.g., by triangulating signals from one or more macro base stations). In this embodiment, the mobile device may be aware of the locations of the source of the signals (e.g., the location of the macro base stations, access points, etc.) in using the triangulation methods. For example, the mobile device may store this location information locally, receive them from a server (e.g., using the macro base station), determine them from the signals, etc.

In one embodiment, the mobile device may receive its location information from the macro base station (or any type of base station) to which it is currently connected. For example, the mobile device may be currently communicating with a macro base station which may be aware of its own location and may provide that location information to the mobile device (possibly with relative distance information from the macro base station). Thus, in one embodiment, the mobile device may simply receive location information of the mobile device. This location information may include a margin of error indication (e.g., radius of error, etc.).

In 604, the current location information may be compared to stored location information of one or more access point base stations to determine if at least one of the access point base stations is in proximity to the mobile device. In some embodiments, the comparison may be performed by the mobile device. For example, the mobile device may have stored the location information for a plurality of access point base stations and compare that location information to its current location information.

In some embodiments, the mobile device may receive (or have previously received) the location information of the plurality of access point base stations from the service provider (e.g., from a macro base station of the service provider). For example, in one embodiment, upon entering or being in a specific region, the mobile device may receive all known location information of access point base stations in the region from the service provider. Alternatively, the mobile device may receive (or have previously received) a complete or partial list of locations of access point base stations from the service provider. The location information of the access point base stations may include longitude, latitude, height information, access point base station ID, PN offset, carrier frequency, and/or other information. A simple example of listing is provided below:

Femto ID=20, location information=lat, long, altitude

Such information may be stored in a local database to the mobile device and/or on a server, e.g., of the service provider of the mobile device, as desired.

However, it may be possible for the mobile device to transmit its current location information to a server (e.g., of the service provider) and have the service provider return in distance from various access point base stations or an indication whether or not to connect to or scan for various access point base stations (e.g., as in 606). Thus, the comparison of current location information to location information of access point base stations may be performed by the service provider (or other server) or by the mobile device, as desired.

In 606, the mobile device may connect to an access point base station of the access point base station based on the comparison in 604. In other words, if the comparison of the current location information to the stored location information of the access point base stations indicates that the mobile device is in proximity to an access point base station, the mobile device may attempt to connect to or communicate with the access point base station (or at least detect its presence). As used herein, “proximity” or “proximate” in the context of mobile devices and access point base stations, refers to the distance within the mobile device may begin to communicate with the access point base station, where the mobile device can begin a handoff process, or the distance where the mobile device may soon begin to communicate with the access point base station.

The mobile device connecting to an access point base station may include the mobile device scanning for the access point base station (or a plurality of access point base stations) that are indicated by the comparison in 604 (e.g., that are proximate to the mobile device.

In one embodiment, connecting to the access point base station may include tuning a receiver to a carrier signal of the access point base station, searching for the access point base station (e.g., a PN offset of the access point base station), decoding one or more access point base station overhead messages, comparing identification information of the access point base station with stored identification information, and/or connecting to the access point base station if the identification information matches the stored identification information. Note that if the identification information does not match, the mobile device may retune its receiver back to the macro base station's (or other base station it was previously connected to) carrier frequency and reconnect.

However, it should be noted that the mobile device may not scan or attempt to connect to the access point base station(s) in response to determining that no access point base stations are in proximity to the mobile device (e.g., as determined in 604). This may improve dramatically on the prior art method where the mobile device constantly checks for nearby access point base stations without being aware if any are nearby or present in the area at all. Such prior art methods also allow for the loss of connectivity or loss of pages (e.g., communication packets) between the mobile device and its current service providing base station (e.g., a macro base station). Additionally, the mobile device may not be sure that the access point base station that it is connecting to is of the service provider the mobile device uses until the final connecting step. Correspondingly, the methods describe herein may increase energy efficient usage (e.g., by avoiding using the battery for the scanning of the prior art) and/or avoiding communication loss during these unnecessary scans. Additionally, in embodiments where the mobile device receives location information of access point base stations which provide service for the service provider of the mobile device, the mobile device may be guaranteed that the access point base station can provide service for the mobile device, thereby improving on the prior art methods.

### Method for Maintaining Location Information

The following description describes an exemplary method for maintaining location information for a plurality of access point base stations. The method described may be used in conjunction with any of the computer systems or devices shown in the above Figures, among other devices. In various embodiments, some of the method elements shown may be performed concurrently, performed in a different order than shown, or omitted. Additional method elements may also be performed as desired. As shown, this method may operate as follows.

The location information of a plurality of access point base stations may be stored (e.g., by a service provider). In one embodiment, this information may be stored for each access point base station each time it is provisioned or set-up. Additionally, the location information may be periodically determined or requested by the service provider, e.g., in order to update the location information for the particular access point base station. The location information may be stored in one or more databases or other files in memory, as desired.

The location information of one or more access point base stations of the plurality of access point base stations may be provided to a mobile device. The location information may be usable by the mobile device to determine whether or not to connect to an access point base station, e.g., as described above in FIG. 6.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A method for detecting and connecting to an access point base station, comprising:
determining current location information of a mobile access terminal;
comparing the current location information to stored location information of one or more access point base stations to determine if at least one of the one or more access point base stations is in proximity to the mobile access terminal, wherein each of the one or more access point base stations is configured to provide wireless communication to mobile access terminals within a local area; and
connecting to an access point base station of the one or more access point base stations if said comparing indicates that at least one of the one or more access point base stations is in proximity to the mobile access terminal.

2. The method of claim 1, wherein said determining current location information comprises using position location circuitry of the mobile access terminal to determine the current location information.

3. The method of claim 1, further comprising:
the mobile access terminal scanning for the one or more access point base stations in response to determining that at least one of the one or more access point base stations is in proximity to the mobile access terminal.

4. The method of claim 3, wherein the mobile access terminal does not scan for the one or more access point base stations in response to determining that no access point base stations are in proximity to the mobile access terminal

5. The method of claim 1, wherein said connecting to the access point base station comprises:
tuning a receiver to a carrier signal of the access point base station;
searching for the access point base station;
decoding one or more access point base station overhead messages;
comparing identification information of the access point base station with stored identification information; and
connecting to the access point base station if the identification information matches the stored identification information.

6. The method of claim 1, wherein the location information comprises one or more of:
latitude information;
longitude information; or
height information.

7. The method of claim 1, wherein said receiving current location information comprises determining the current location information based on signals received from one or more macro base stations.

8. The method of claim 1, wherein said determining comprises triangulation of the signals received from the one or more macro base stations.

9. The method of claim 1, wherein said comparing uses a radius of error of the current location information and a definition of a local area of the one or more access point base stations.

10. A mobile device, comprising:
at least one wireless port for providing bi-directional communication with one or more base stations;
positioning location circuitry;
a processor coupled to the at least one wireless port and the position location circuitry;
a memory medium coupled to the processor, wherein the memory medium comprises program instructions executable by the processor to:
determine current location information of the mobile device using the positioning location circuitry;
compare the current location information to stored location information of one or more access point base stations to determine if at least one of the one or more access point base stations is in proximity to the mobile device, wherein each of the one or more access point base stations is configured to provide wireless communication to mobile devices within a local area; and
connect to an access point base station of the one or more access point base stations if said comparing indicates that at least one of the one or more access point base stations is in proximity to the mobile access terminal.

11. The mobile device of claim 10, wherein the program instructions are further executable by the processor to:
scan for the one or more access point base stations in response to determining that at least one of the one or more access point base stations is in proximity to the mobile device.

12. The mobile device of claim 11, wherein the program instructions are not executable to scan for the one or more access point base stations in response to determining that no access point base stations are in proximity to the mobile device

13. The mobile device of claim 10, wherein the program instructions are further executable by the processor to:
tune a receiver to a carrier signal of the access point base station;
search for the access point base station;
decode one or more access point base station overhead messages;
compare identification information of the access point base station with stored identification information; and
connect to the access point base station if the identification information matches the stored identification information.

14. The mobile device of claim 10, wherein the location information comprises one or more of:
latitude information;
longitude information; or
height information.

15. The mobile device of claim 10, wherein said comparing comprises using a radius of error of the current location information and a definition of a local area of the one or more access point base stations.

16. A memory medium storing program instructions for connecting a mobile device to a femtocell, wherein the program instructions are executable to:
determine current location information of the mobile device;
compare the current location information to stored location information of one or more femtocells to determine if at least one of the one or more femtocells is in proximity to the mobile device, wherein each of the one or more femtocells is configured to provide wireless communication to mobile devices within a local area; and
connect to the femtocell of the one or more femtocells based on said comparing if said comparing indicates that at least one of the one or more femtocells is in proximity to the mobile device.

17. The memory medium of claim 14, wherein said determining current location information comprises using positioning location circuitry to determine the current location information.

18. The memory medium of claim 14, wherein the program instructions are further executable to:
scan for the one or more femtocells in response to determining that at least one of the one or more femtocells is in proximity to the mobile device.

19. A method for providing information for connecting to an access point base station, comprising:
storing location information for a plurality of access point base stations; and
providing the location information for the plurality of access point base stations to a mobile device, wherein the location information is usable by the mobile device to determine whether or not to connect to an access point base station.

20. The method of claim 19, wherein the location information comprises a set of any combinations of the followings:
latitude information;
longitude information; or
height information.
